(19) United States
(12) Patent Application Publication
(10) Pub. No.: US 2013/0334816 A1
(43) Pub. Date: Dec. 19, 2013

(54) Method for Operating a Wave Energy Converter for Converting Energy from a Wave Motion of a Fluid into another Form of Energy

(71) Applicant: Robert Bosch GmbH, Stuttgart (DE)

(72) Inventors: Nicolas Houis, Bietigheim-Bissingen (DE); Benjamin Hagemann, Norderstedt (DE); Alexander Poddey, Wiernsheim (DE)

(21) Appl. No.: 13/916,320

(22) Filed: Jun. 12, 2013

(30) Foreign Application Priority Data
Jun. 18, 2012 (DE) 10 2012 012 096.6

(51) Int. Cl. F03B 13/14

(52) U.S. Cl. CPC F03B 13/14
USPC 290/42

(57) ABSTRACT

A method for operating a wave energy converter for converting energy from a wave motion of a fluid into another form of energy, wherein the wave energy converter has a lever arm, which is mounted so as to be rotatable about a rotor rotational axis and bears a coupling body and an energy converter which is coupled to the rotatably mounted lever arm, includes controlling a rotational speed of the lever arm about the rotor rotational axis such that, averaged over time over one revolution, it corresponds to an orbital speed of the wave motion, and controlling the rotational speed of the lever arm such that an angle between a tangential speed of the coupling body and of a local flow rate of the wave motion about the coupling body deviates at maximum by a predefinable value of 90°.

This application claims priority under 35 U.S.C. §119 to patent application no. DE 10 2012 012 096.6, filed on Jun. 18, 2012 in Germany, the disclosure of which is incorporated herein by reference in its entirety.

The present disclosure relates to a method for operating a wave energy converter for converting energy from a wave motion of a fluid into another form of energy, a computing unit for executing said method and a wave energy converter.

### BACKGROUND

Wave power plants (wave energy converters) convert the energy from sea waves into another form of energy, for example in order to produce electric current. Relatively new design approaches in this context use rotating units (rotors) which convert the wave motion into a torque. On the latter, it is possible to use hydrodynamic buoyant bodies (i.e. bodies which generate lift when there is a flow around them, such as, for example, lift profile sections and/or Flettner rotors using the Magnus effect) as coupling bodies by means of which lift forces are generated from the inflowing wave and a torque is generated by the arrangement of the coupling bodies on the rotor, which torque can be converted into a rotational movement of the rotor. A superimposed flow from the orbital flow of the wave motion and of the intrinsic rotation of the rotor results in lift forces on the coupling bodies, as a result of which a torque is applied to the rotor. The publication by Pinkster et al., “A rotating wing for the generation of energy from waves”, 22. International Workshop on Water Waves and Floating Bodies (IWWWFB), Plitvice, 2007, discloses in this context a system concept in which the lift of a floating body on which there is a flow is converted into a rotational motion. GB 2 226 572 A discloses a wave energy converter with Flettner rotors.

It is desirable to improve the operation of wave energy converters of the generic type.

### SUMMARY

According to the disclosure, a method is proposed for operating a wave energy converter for converting energy from a wave motion of a fluid into another form of energy, a computing unit for executing said method and a wave energy converter having the features described herein. Advantageous refinements are the subject matter of the following description.

The disclosure provides the possibility of operating a wave energy converter with the highest possible energy yield. This is achieved in that the positioning and/or orientation of the coupling body which is attached to a lever arm is predefined relative to the surrounding flow in such a way that a drive torque which is as high as possible acts on the lever arm which rotates about a rotor rotational axis.

According to a first aspect of the disclosure, for this purpose the wave energy converter is operated in such a way that the local orbital flow at the coupling body and the incoming flow resulting from the rotation of the lever arm about the rotor rotational axis are oriented substantially perpendicularly with respect to one another. This is achieved by correspondingly influencing the rotational speed of the lever arm about the rotor rotational axis. The rotational speed of the lever arm is preferably influenced by influencing the drive torque and/or the extracted torque (load torque). The drive torque can be changed, in particular, by setting the pitch angle (angle between the tangent to the circular motion of the coupling body about the rotor rotational axis and the profile chord of the coupling body) of a hydrodynamic coupling body or by setting the intrinsic rotational speed of a Flettner rotor. The load torque can be changed by setting the energy converter, in particular an electrical generator. The disclosure preferably makes use here of the control concept of a wave energy converter with a rotor and at least one coupling body attached thereto, as described in DE 10 2011 105 177 which is by the applicant and was published after the priority date of the present document. The disclosure in DE 10 2011 105 177 is incorporated herein by reference in its entirety.

DE 10 2011 105 177 describes a synchronicity condition according to which the rotational speed of the rotor or of the lever arm is controlled in such a way that averaged over time it corresponds to the orbital speed (i.e. the rotational speed of the wave vector at the rotor axis) of the wave motion. Certain deviations may also be permitted but are not quantified. This operating method is developed by the present disclosure. Within the scope of the disclosure, the described synchronicity condition is developed in such a way that the angular speed of the lever arm corresponds, averaged over time over one revolution, to the angular speed of the wave motion, but in the interim there are deviations, i.e. at least one revolution phase in which the lever arm rotates faster than the orbital movement is predefined, and at least another phase in which the lever arm rotates more slowly than the orbital motion is predefined. The rotational speed of the lever arm is controlled here in such a way that, as required above, the local orbital flow at the coupling body and the incoming flow resulting from the rotation of the lever arm about the rotor rotational axis are oriented substantially perpendicularly with respect to one another, that is to say the angle between a tangential speed of the coupling body and a local flow rate of the wave motion about the coupling body deviates by at most a predefinable value of 90°. The permissible range about 90° is expediently not too large, in particular it comprises values ±25°, ±10° or less.

The actuation is preferably carried out in such a way that the rotational speed of the lever arm about the rotor rotational axis is, in particular always, slower than the orbital speed of the wave motion, if the specified rotational speed contains a speed component which is in the same direction as the wave propagation speed and that it is, in particular always, faster than the orbital speed of the wave motion, if it contains a speed component which is in the opposite direction to the wave propagation speed.

Furthermore, a wave energy converter is proposed which has at least two lever arms which each bear a coupling body, wherein the angle which is formed at the rotor rotational axis by the lever arms can be changed. This particularly advantageously permits the angular positions and rotational speeds of the lever arms to be set independently of one another, with the result that for each of the lever arms the local orbital flow at the secured coupling body and the incoming flow owing to the rotation of the lever arm about the rotor rotational axis are, as described, oriented substantially perpendicularly with respect to one another.

According to a further aspect of the disclosure, the respective pitch angle of a hydrodynamic coupling body is set in such a way that the highest possible drive torque is produced. This is done by determining a dependence of, in each case, the lift coefficient and the resistance coefficient of the coupling body on an inflow angle (i.e. the angle between the resultant inflow and the profile chord of the coupling body) and by maximizing the effective force resulting from the lift force and the resistance force, by varying the inflow angle with the condition that no complete flow detachment occurs. The necessary pitch angle is readily obtained from the inflow angle which is determined in this way. A preferred determining method is used further below with reference to FIGS. 3 and 4.

A computing unit according to the disclosure, for example a control unit of a wave energy converter, is configured, in particular in programming terms, to carry out a method according to the disclosure.

It is advantageous to implement the disclosure in the form of software since this permits particularly low costs, in particular if a computing unit which is to be implemented is also used for other tasks and is therefore present in any case. Suitable data carriers for making available the computer program are, in particular, diskettes, hard disks, flash memories, EEPROMs, CD-ROMs, DVDs etc. It is also possible to download a program via computer networks (Internet, Intranet etc.).

Further advantages and refinements of the disclosure can be found in the description and the appended drawing.

Of course, the features which are mentioned above and which are to be explained below can be used not only in the respectively specified combination but also in other combinations or alone without departing from the scope of the present disclosure.

### BRIEF DESCRIPTION OF THE DRAWINGS

The disclosure is illustrated schematically in the drawing using exemplary embodiments and is described in detail below with reference to the drawings, in which:

FIG. 1 shows a preferred embodiment of a wave energy converter according to the disclosure in a perspective view;

FIG. 2 shows the wave energy converter according to FIG. 1 in a side view and illustrates the pitch angle α_{P} and the phase angle Δ between the rotor and the orbital flow;

FIG. 3 shows the resultant inflow angle α₁ and α₂ and the resultant forces at the coupling bodies of the rotor from FIG. 2;

FIG. 4 shows the region around one of the coupling bodies from FIG. 3 in an enlarged view;

FIG. 5a shows the rotational angle of a lever arm plotted over the time for a wave energy converter operated according to a preferred embodiment;

FIG. 5b shows the associated rotational speed of the lever arm plotted against the angular position;

FIG. 6a shows a schematic side view of a further preferred embodiment of a wave energy converter according to the disclosure with lever arms which can be pivoted relative to one another, in the straight state for vertical orbital flow; and

FIG. 6b shows the wave energy converter according to FIG. 6a with pivoted lever arms.

### DETAILED DESCRIPTION

In the figures, identical or identically acting elements are specified with identical reference symbols. For the sake of clarity, the explanation will not be repeated.

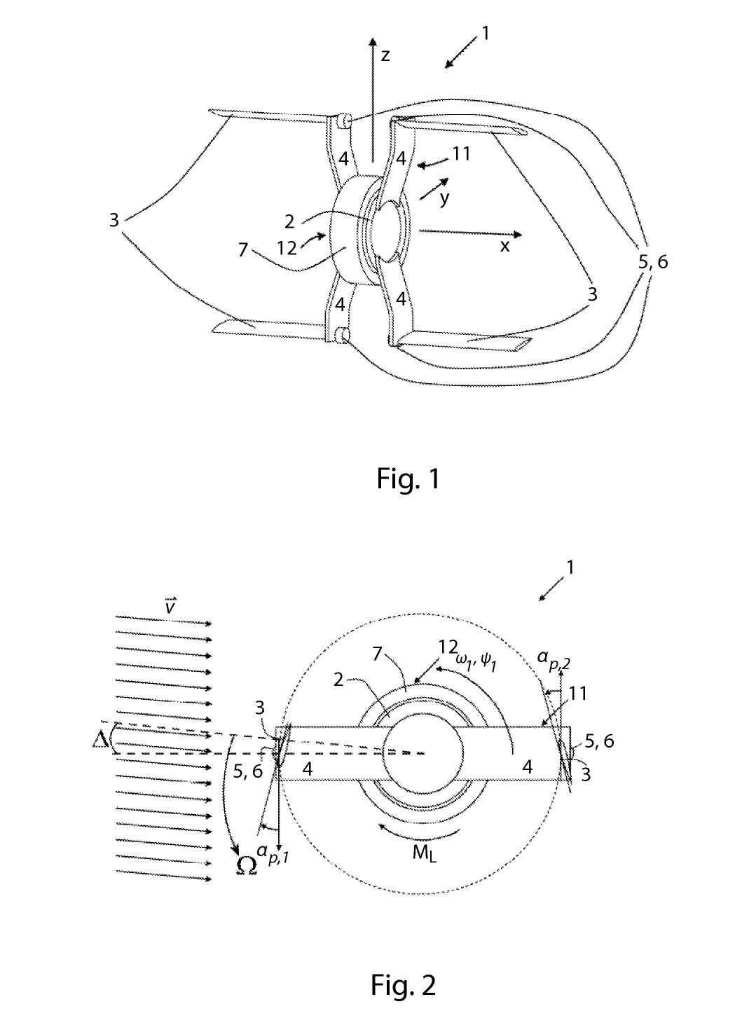

The disclosure which is presented relates to the operation of rotating systems for acquiring energy from moving fluids, for example from the sea. The functional principle of such systems will be firstly explained below with reference to FIGS. 1 to 3.

FIG. 1 shows a wave energy converter 1 with a rotor base 2, a housing 7 and four coupling bodies 3 which are respectively attached via lever arms 4 to the rotor base 2. The wave energy converter 1 is provided for operating below the water surface of a body of water where there is wave action, for example an ocean. In the example shown, the coupling body 3 is embodied in a profiled fashion, but can also be embodied as Flettner rotors, i.e. cylinders with additional intrinsic rotation. An adjustment device 5 with at least one degree of freedom is expediently available for each of the coupling bodies 3 in order to change the orientation (for example “pitch angle”, i.e. the angle between the profile chord and the tangential speed) of the respective coupling body and therefore influence the interaction between the fluid and the coupling body. The degree of freedom of the adjustment devices is described here by adjustment parameters (pitch angle). Alternatively, in the case of Flettner rotors as coupling bodies the rotational speed of the Flettner rotors can also be adapted. The adjustment devices are preferably electromotive adjustment devices. A sensor system 6 for sensing the current adjustment is also preferably available. The components 2, 3, 4, 5, 6 are components for a rotor 11 which rotates about a rotor rotational axis x.

The housing 7 is a component of a frame 12. The rotor 11 is mounted so as to be rotatable relative to the frame 12. In the example shown, the frame 12 is connected in a rotationally fixed fashion to a stator of a directly driven generator for generating current, and the rotor 11 (here the rotor base 2) is connected in a rotationally fixed fashion to a rotor of this directly driven generator. It is also possible to provide a transmission between the rotor base and the generator rotor. A computing unit which is configured to carry out a method according to the disclosure is arranged inside the housing 7 and serves to control the operation of the wave energy converter 1. A predefined means of attaching the wave energy converter 1 to the seabed, which can also be done by means of a mooring system, for example, is not illustrated.

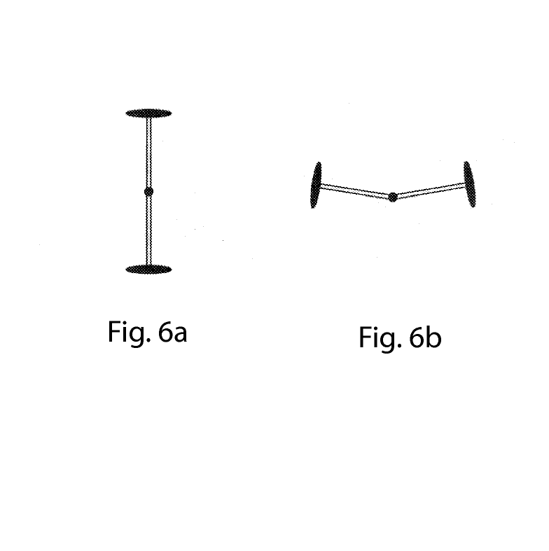

The lever arms 4 are arranged on each rotor side in a basic position at an angle of 180° with respect to one another. According to one preferred embodiment, as illustrated in FIG. 6, the lever arms 4, which lie opposite one another on one side of the rotor, can be pivoted with respect to one another in the plane of rotation, i.e. the angle between the lever arms can be changed by 180° within a certain range. For this purpose, drives, brakes and/or a sensor system are/is provided.

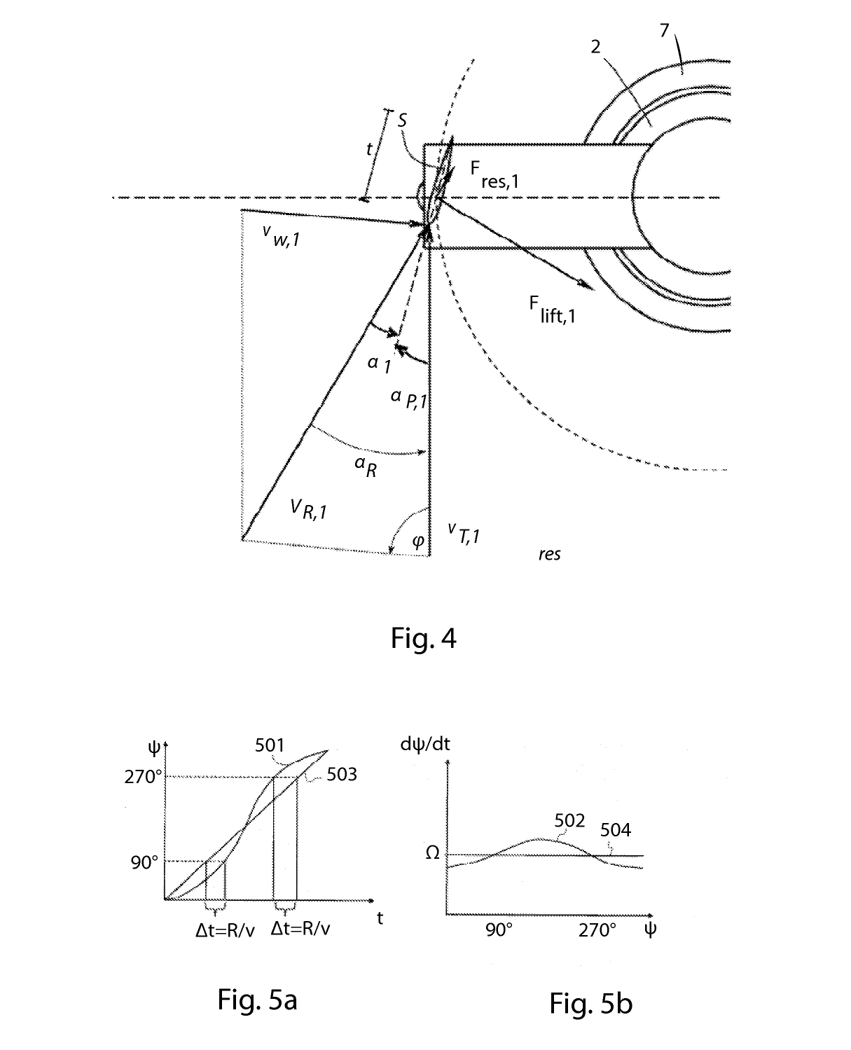

FIG. 2 shows a side view of the system with lever arms rotated through 90° with respect to the position shown in FIG. 1. The adjustment parameters can be seen as the pitch angle α_{P,i} between the profile chord S (see FIG. 4) of the coupling bodies 3 and the tangent (illustrated with an arrow; see also ν_{T,1} in FIG. 4) on the orbit through the suspension point (center of rotation) of the coupling bodies. The coupling bodies 3 are preferably suspended at their center of rotation in order to reduce rotational moments which occur during operation and act on the coupling bodies, and therefore to reduce the requirements made of the securing and/or of the adjustment devices.

The coupling bodies in FIG. 2 and in the further figures are illustrated only by way of example in order to define the different machine parameters. During operation the pitch angle of the two coupling bodies is preferably implemented in a way opposed to that in the illustration. The coupling body on the left in FIG. 2 would then be adjusted inward, and the coupling body on the right in FIG. 2 outward. In addition, curvature of the coupling bodies against the orbit can also be advantageous.

The wave energy converter 1 is surrounded by a flow vector field. In the described embodiments, it is assumed that the inflow comprises the orbital flow of sea waves whose direction changes continuously. In the illustrated case, the rotation of the orbital flow is oriented in the counter-clockwise direction, and the associated wave therefore propagates from right to left. In the monochromatic case, the inflow direction changes at the rotor rotational axis (x in FIG. 1) here with the angular speed Ω=2πf=const., wherein f represents the frequency of the monochromatic wave. In contrast, in multichromatic waves, Ω is subject to change over time, Ω=ƒ(t) since the frequency f is a function of time, f=ƒ(t). The inflow results in forces at the coupling bodies. As a result, the angle ψ₁ of the rotor base 2 with respect to the horizontal changes with the rotational speed ω₁=\dot{ψ}₁ (\dot{ψ}₁ denotes the derivation of the time-dependent variable ψ₁ over time). It is a provision that the lever arm 4 rotates, averaged over time, synchronously with the orbital flow of the wave motion with ω₁. Here, Ω≈ω₁, for example. A value or a value range for an angular speed ω₁ of the rotor is therefore predefined on the basis of an angular speed Ω of the orbital flow or adapted thereto. In this context, constant control or brief adaptation can take place.

A variable load torque M_{L} between the rotor base 2 and the housing 7 or frame 12 acts at the rotor 11. The load torque can act in a positive direction (in the opposite direction to the rotational speed ω₁) but also in the negative direction (that is to say in a driving fashion). The load torque is caused, for example, by power generation in the generator.

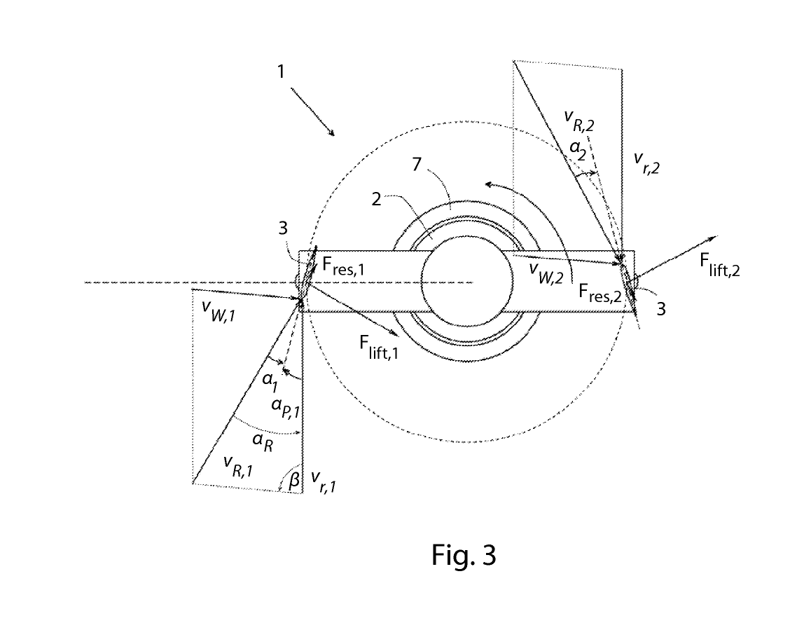

An angle between the rotor orientation, illustrated by a lower dashed line which runs through the rotor rotational axis and the center of the two adjustment devices 5, and the direction of the orbital flow, which is illustrated by an upper dashed line which runs through one of the speed arrows \vec{ν} is referred to as phase angle Δ whose absolute value can be influenced by the setting of the drive torque and/or of the load torque. Therefore, a phase angle at the rotor rotational axis from −25° to 25°, preferably from −10° to 10° and particularly preferably from approximately 0° is particularly advantageous for generating the drive torque since in this context the orbital flow ν_{w} (W for wave) and the inflow owing to the intrinsic rotation ν_{T} (T for tangent) (see FIG. 3) are oriented largely perpendicularly with respect to one another, which causes the absolute value of the resultant inflow ν_{R} (R for result) to be maximized.

FIGS. 3 and 4 illustrate the resulting inflow conditions and the forces which occur at the coupling bodies, which give rise to a drive torque. It is to be noted that even in the case of monochromatic waves (a wavelength and amplitude) in rotors with large diameters the coupling bodies 3 are located at different positions relative to the wave during a revolution, which leads to a locally different inflow direction. It is possible to react to this by changing the rotational speed of the lever arm or lever arms about the rotor rotational axis and/or by using an individual setting of the respective pitch angle α_{P}, as explained further below.

FIGS. 3 and 4 illustrate, on the two coupling bodies (index i), the local inflows through the orbital flow (ν_{W,i}) and through the intrinsic rotation (ν_{T,i}), the inflow (ν_{R,i}) resulting from these two inflows and the resulting inflow angles αᵢ between the resulting inflow ν_{R} and the profile chord S. Furthermore, the resulting lift forces F_{lift,i}, and resistance forces F_{res,i} at the two coupling bodies are illustrated, said lift forces F_{lift,i} and resistance forces F_{res,i} are dependent both on the absolute value of the inflow speed ν_{R,i} as well as on the inflow angles αᵢ and therefore also on the pitch angles α_{P,1} and α_{P,2} and, as is known, are oriented perpendicularly (F_{lift,i}) and respectively in parallel (F_{res,i}) with respect to the direction of ν_{R,i}.

Steady-state multichromatic waves (waves with a plurality of different frequency components and amplitude components, but these components are constant) or multichromatic waves (the frequency components and amplitude components are variable over time), an effectively resulting value, for example a mean value or a value of the main component, can be used as a local orbital flow (ν_{W,i}). The local orbital flow can be measured or calculated. For example, the wave height can be measured at a location at which the wave passes the wave energy converter chronologically. The angular position of the coupling body can also be measured. It is possible to carry out a spectral analysis in order to determine the frequency components and amplitude components. These data can then be used to adjust a model (for example monochromatically on the basis of the main frequency component, multichromatically with a limited number of steady-state components or components which are variable over time, non-linear wave models) for describing the propagation of waves and the resulting flow conditions. The inflow direction and, if appropriate, inflow speed to be expected according to the model at the location of the coupling body can be calculated in order to achieve a suitable inflow angle. For example, the local flow conditions can also be calculated or estimated from a model of the wave propagation such as is described, for example, in EP 11009798.7, which was published after the priority date of the present document.

For the case illustrated, the two lift forces F_{lift,i} result in a rotor torque in the counter-clockwise direction, and the two resistance forces F_{res,i} result in a rotor torque which is smaller in absolute terms and is in the opposite direction (that is to say in the clockwise direction). The sum of the two rotor torques brings about rotation of the rotor 11 whose speed can be set by influencing the drive torque and/or the load torque.

The absolute value of the speed of the resulting inflow is obtained as:

ν_{R}={square root over (ν_{T}−ν_{W} cos β)²+(ν_{W} sin β)²)},

wherein β is the angle between ν_{T} and ν_{W}.

The inflow angle is obtained as:

$$α = \underbrace{arc sin ( \frac{sin β}{{v}_{T}} {v}_{W} )}_{{α}_{R}} - {α}_{P}$$

The first term describes here an angle α_{R} between ν_{R} and ν_{T}.

The described forces are then obtained as

$${F}_{Auf} = \frac{ρ}{2} \cdot b \cdot t \cdot {v}_{T}^{2} \cdot {c}_{a} ( α )$$

$${F}_{Wid} = \frac{ρ}{2} \cdot b \cdot t \cdot {v}_{T}^{2} \cdot {c}_{w} ( α )$$

with the fluid density ρ, wing span b (length of the coupling body in FIG. 3 perpendicular to the plane of the drawing), profile chord length t, lift coefficient cₐ and resistance coefficient c_{w}.

To determine the coefficients, angle-dependent measurements and flow simulations are expediently carried out. Since the shape of the profile and the Reynolds number during operation are fixed and are therefore not manipulated variables, the inflow angle α is considered to be the only manipulated variable.

An effective force F_{eff} which acts on the lever arm in the tangential direction is obtained as:

F_{eff}=F_{Auf} sin(α−α_{P})−F_{Wid} cos(α−α_{P})

The drive torque is obtained by F_{eff}x lever arm length.

If the resulting effective force is positive, this brings about a rotation in the counter-clockwise direction.

α depends on the parameters which can be determined, with the result that α_{P} can be set in such a way that the effective force gives rise to the largest possible drive torque. In this context, complete flow detachment, which occurs at excessively large inflow angles, is to be avoided. For this purpose, what is referred to as a critical detachment angle is expediently taken into account, said angle depending on the shape of the profile and the Reynolds number.

Overall, the pitch angle which gives rise to the largest possible drive torque is obtained according to:

$$tan {{α}_{R} ( \frac{\partial {c}_{a}}{\partial α} )}_{α = {α}_{max}} = {( \frac{\partial {c}_{w}}{\partial α} )}_{α = {α}_{max}}$$

$${α}_{P} = {α}_{R} - {α}_{max}$$

The speed and direction of ν_{w} can be particularly preferably measured at the location of the coupling body by means of suitable sensors in order to determine α_{R} therefrom. It can also be developed from a value at another measuring location, for example the rotor rotational axis, as explained below.

For the following considerations it is assumed that the direction of ν_{W} is known centrally at the rotor rotational axis of the wave energy converter, for example by measuring. The drive torque is, however, dependent on the direction and absolute value of the wave vector ν_{W,local} directly at the location of the coupling body. This can be determined as explained below. Alternatively, the local inflow waves at the coupling body can be determined by suitable sensor systems (for example ultrasonic sensors, pressure sensors on the coupling bodies).

When the deep water condition is met (distance from surface to the seabed>half wavelength L), it is possible to calculate the absolute value for a monochromatic wave (wave height or amplitude H and a wavelength L (->wave period T)) as a function of the depth according to:

$${v}_{W} ( z ) = \frac{π \cdot H}{T} {e}^{\frac{2 π}{L} z}$$

The water depth z is measured negatively here from the calm water surface in the direction of the seabed.

For the current distance z of the coupling body from the at-rest water level the following applies:

z=z₀−R sin Ψ₁

Here, z₀ denotes the distance between the rotor rotational axis and the at-rest water line, R denotes the radius of the movement orbit of the coupling body and Ψ₁ denotes the rotational angle of the lever arm with respect to the horizontal x axis.

In the case of synchronous operation and a large diameter or radius R, the wave inflow direction can remain synchronous with the rotor rotation over time only at the rotor rotational axis. As a result of the spatial extent of the rotor, the direction of ν_{W,local} at the coupling body corresponds to the direction of ν_{W} at the rotor rotational axis only at a 6 o'clock or 12 o'clock position of the lever arm. In all the other positions, the direction of ν_{W,local} at the coupling body has a phase shift δ with respect to ν_{W} at the rotor rotational axis. The phase shift is dependent on the rotational angle β and the wavelength L according to:

$$δ = 2 π \cdot \frac{R}{L} cos β$$

ν_{W,local} follows ν_{W} at the rotational axis in the case of a downward movement (corresponds to the side of the rotor facing away from the wave propagation direction). In the case of an upward movement the inverted conditions apply.

For the following consideration, in contrast to that stated above, it is assumed that the wave propagation speed runs from left to right and the rotor or lever arm rotates in the clockwise direction with ω=Ω (continuously wave-synchronous) about the rotor rotational axis. In the case of a rotor with a lever arm with a large lever arm length the following situation results here:

In the 12 o'clock position the coupling body is at its top reversal point and is also flowed against from above, as is also the center (rotor rotational axis).

In the 3 o'clock position, the center (rotor rotational axis) is flowed against from the right. Owing to the large rotor diameter compared to the wavelength, the coupling body is, however, located in a region in which the flow ν_{W,local} is directed obliquely upward. The local wave follows the wave in the rotor center here with the result that in the case of continuously wave-synchronous rotation of the lever arm the coupling body is not optimal here but instead there is an oblique flow against it from top right.

In the 6 o'clock position, the coupling body is flowed against from below. Here, a positionally correct inflow is achieved independently of the diameter, as also in the case of 12 o'clock.

In the 9 o'clock position, the center (rotor rotational axis) is flowed against from the left. Owing to the large diameter compared to the wavelength, the coupling body is, however, located in a region in which the flow ν_{W,local} is directed obliquely downward. The local wave is in advance of the wave in the rotor center here, with the result that in the case of continuously wave-synchronous rotation of the lever arm the coupling body is not optimal here but instead has an oblique flow against it from top left.

A preferred reaction possibility to the described fact that in the case of continuous wave synchronicity the direction of ν_{W,local} on the coupling body corresponds to the direction of ν_{W} at the rotor rotational axis only at the 6 o'clock and 12 o'clock positions of the lever arm, is a corresponding deviation from the continuous wave synchronicity by varying the rotational speed of the lever arm about the rotor rotational axis.

Here, the realization is preferably used that the absolute value of the resulting inflow ν_{R}, and therefore also the drive torque, can be maximized independently of the pitch angle if the angle φ between ν_{T} and ν_{W} is 90°. According to a further preferred embodiment, the rotational speed of a lever arm about the rotor rotational axis is therefore set in such a way that the angle φ between ν_{T} and ν_{W} is substantially always approximately 90°, and therefore varies at most within a certain region about 90°. The rotational speed of a lever arm is therefore controlled in such a way that, averaged over time over one revolution, it corresponds to the orbital speed of the wave motion, but is slower than the orbital speed of the wave motion when the motion of the coupling body contains a speed component which is in the same direction as the wave propagation speed (that is to say between 9 o'clock and 3 o'clock), and wherein it is faster than the orbital speed of the wave motion when the motion of the coupling body contains a speed component which is in the opposite direction to the wave propagation speed (that is to say between 3 o'clock and 9 o'clock). The rotational speed of the lever arm is also controlled in such a way that it corresponds to the orbital speed of the wave motion, if the speed of the coupling body is perpendicular to the wave propagation speed (that is to say at 3 o'clock and 9 o'clock). Targeted deviation from the continuous wave synchronicity is therefore brought about, as described below and illustrated in FIGS. 5a and 5b. The angular position of a coupling body of a wave energy converter operated according to the disclosure plotted against the time t is denoted therein by 501, and the angular speed or rotational speed plotted against the angular position Ψ by 502. The angular position of a coupling body of a wave energy converter which is continuously operated wave-synchronously, plotted against the time t, is denoted therein by 503, and the angular speed or rotational speed plotted against the angular position φ by 504. It is immediately clear that the rotational speed 504 is continuously Ω.

At the 12 o'clock position (0° in FIG. 5), the lever arm is flowed against from above. In this region, the lever arm has a lower rotational speed 502 than a synchronous rotor, but also accelerates in a position-dependent and inflow-dependent fashion. This causes the synchronous rotor to lag behind in the further course of the process.

If the lever arm reaches the 3 o'clock position (90°), the largest phase offset Δt with respect to a synchronous rotor is reached. The time difference corresponds here to the ratio between the lever arm length r and the propagation speed v of the shaft, with the result that the 3 o'clock position is not reached until the local inflow is horizontal from right to left there. As mentioned, the rotational speed 502 of the lever arm corresponds here largely to the orbital speed Ω of the wave motion and therefore to the rotational speed 504 of a synchronous rotor.

The 6 o'clock position (180°) is reached by the lever arm largely at the same time as the synchronous rotor. The lever arm is largely flowed against from below. The rotational speed 502 is greater here than the rotational speed 504 of a synchronous rotor.

If the lever arm reaches the 9 o'clock position (270°), the greatest phase offset Δt with respect to a synchronous rotor is reached again. The time difference corresponds largely to the ratio between the lever arm length r and the propagation speed v of the wave, with the result that the 9 o'clock position is already reached when the local inflow is horizontal from left to right there. As mentioned, the rotational speed 502 of the lever arm corresponds largely here to the orbital speed Ω of the wave motion and therefore to the rotational speed 504 of a synchronous rotor.

Between 9 o'clock and 12 o'clock, the lever arm rotates more slowly than the synchronous rotor, with the result that it reaches the 12 o'clock position (360°/0°) largely at the same time as the synchronous rotor.

The change in the rotational speed such that the course described above occurs can be brought about by changing the load torque—that is to say, for example, the generator torque—and/or by changing the drive torque—for example by pitch adjustment or adjustment of the intrinsic rotational speed of a Flettner rotor. In this context, it is possible, depending on the coupling body geometry and rotor geometry, for a reduction in the load torque, and/or an increase in the drive torque to bring about an acceleration, or for an increase in the load torque and/or a reduction in the drive torque to bring about braking, of the rotation of the lever arm about the rotor rotational axis. Both variables can be influenced by means of a corresponding control system, for example according to DE 10 2011 105 177.

FIGS. 6a and 6b illustrate in schematic side views a further preferred embodiment of a wave energy converter according to the disclosure. The wave energy converter has two lever arms which can be pivoted relative to one another, with the result that the rotational speed of each lever arm can be predefined independently of that of the other lever arm, in particular as explained with reference to FIGS. 5a and 5b. As described, the position at 0° and 180° is wave-synchronous, with the result that here the precise arrangement according to FIG. 6a occurs. At 90°, a following movement occurs and at 270° movement in advance occurs, with the result that the angular arrangement according to FIG. 6b occurs here.

1. A method for operating a wave energy converter configured to convert energy from a wave motion of a fluid into another form of energy, wherein the wave energy converter has (i) a lever arm mounted so as to be rotatable about a rotor rotational axis and including a coupling body, and (ii) an energy converter coupled to the rotatably mounted lever arm, the method comprising:
controlling a rotational speed of the lever arm about the rotor rotational axis such that the rotational speed of the lever arm, averaged over time over one revolution, corresponds to an orbital speed of the wave motion; and
controlling the rotational speed of the lever arm such that an angle between a tangential speed of the coupling body and of a local flow rate of the wave motion about the coupling body deviates by a predefinable value that is less than or equal to 90°.

2. The method according to claim 1, wherein the predefinable value is less than or equal to 25°.

3. The method according to claim 2, wherein the predefinable value is 0°.

4. The method according to claim 1, further comprising:
controlling the rotational speed of the lever arm such that the rotational speed of the lever arm is less than the orbital speed of the wave motion if the motion of the coupling body has a speed component in the same direction as a wave propagation speed; and
controlling the rotational speed of the lever arm such that the speed of the lever arm is greater than the orbital speed of the wave motion if the speed component is in a direction opposite to the wave propagation speed.

5. The method according to claim 4, further comprising:
controlling the rotational speed of the lever arm such that the rotational speed of the lever equals the orbital speed of the wave motion if the speed component of the coupling body is perpendicular to the wave propagation speed.

6. The method according to claim 1, further comprising:
measuring one of the tangential speed of the coupling body and the local flow rate of the wave motion about the coupling body.

7. The method according to claim 1, further comprising:
calculating the local flow rate of the wave motion about the coupling body starting from at least one of a first local flow rate of the wave motion at the rotor rotational axis, a second local flow rate of the wave motion at a position on the wave energy converter, and a third local flow rate of the wave motion at a position in the fluid around the wave energy converter.

8. The method according to claim 1, further comprising:
setting a pitch angle of the coupling body with reference to a lift coefficient cₐ and a resistance coefficient c_{w} of the coupling body,
wherein the coupling body is a hydrodynamic coupling body.

9. The method according to claim 8, further comprising:
setting the pitch angle with reference to a dependence of the lift coefficient cₐ and of the resistance coefficient c_{w} on an inflow.

10. The method according to claim 9, further comprising:
setting the pitch angle according to:
$$tan {{α}_{R} ( \frac{\partial {c}_{a}}{\partial α} )}_{α = {α}_{max}} = {( \frac{\partial {c}_{w}}{\partial α} )}_{α = {α}_{max}}$$
$${α}_{P} = {α}_{R} - {α}_{max}$$
wherein:
α_{R} is an angle between a tangential speed of the coupling body and a flow rate which results from the tangential speed of the coupling body and of the local flow rate of the wave motion around the coupling body,
α is an inflow angle, and
α_{P} is the pitch angle.

11. A computing unit configured to operate a wave energy converter having (i) a lever arm mounted so as to be rotatable about a rotor rotational axis and including a coupling body, and (ii) an energy converter which is coupled to the rotatably mounted lever arm,
wherein the computing unit is configured to (i) control a rotational speed of the lever arm about the rotor rotational axis such that the rotational speed of the lever arm, averaged over time over one revolution, corresponds to an orbital speed of the wave motion, and (ii) control the rotational speed of the lever arm such that an angle between a tangential speed of the coupling body and of a local flow rate of the wave motion about the coupling body deviates by a predefinable value that is less than or equal to 90°.

12. A wave energy converter for converting energy from a wave motion of a fluid into another form of energy, comprising:
a lever arm (i) mounted so as to be rotatable about a rotor rotational axis and (ii) bearing a coupling body;
an energy converter coupled to the rotatably mounted lever arm; and
a computing unit according to claim 11.

13. A wave energy converter for converting energy from a wave motion of a fluid into another form of energy, comprising:
at least two lever arms which are mounted so as to be rotatable about a rotor rotational axis, each of which bears a coupling body,
wherein the angle defined by the at least two lever arms on the rotor rotational axis is variable.

14. The wave energy converter according to claim 13, further comprising:
a computing unit configured to (i) control a rotational speed of the at least two lever arms about the rotor rotational axis such that the rotational speed of the lever arm, averaged over time over one revolution, corresponds to an orbital speed of the wave motion, and (ii) control the rotational speed of the at least two lever arms such that an angle between a tangential speed of the coupling bodies and of a local flow rate of the wave motion about the coupling bodies deviates by a predefinable value that is less than or equal to 90°.

15. The method according to claim 1, wherein the predefinable value is less than or equal to 10°.
